(19) United States
(12) Patent Application Publication
(10) Pub. No.: US 2026/0330542 A1
(43) Pub. Date: Oct. 22, 2026

(54) USING GENERATIVE AI TO DETERMINE WHETHER ITEMS AVAILABLE FROM AN E-COMMERCE SITE ARE LEASABLE

(71) Applicant: RENT-A-CENTER WEST, INC., Plano, TX (US)

(72) Inventors: Matthew Larry HARDY, Midvale, UT (US); Jared DINERSTEIN, Biuffdale, UT (US)

(73) Assignee: RENT-A-CENTER WEST, INC., Plano, TX (US)

(21) Appl. No.: 19/349,482

(22) Filed: Oct. 3, 2025

Related U.S. Application Data
(63) Continuation-in-part of application No. 19/184,948, filed on Apr. 21, 2025, now abandoned.

(51) Int. Cl. G06Q 30/0645; G06Q 30/0601

(52) U.S. Cl. CPC G06Q 30/0645; G06Q 30/06333; G06Q 30/0641

(57) ABSTRACT

In an embodiment, a computer-implemented method for enabling an interface to an e-commerce site. Data describing the at least one item from a retail ecommerce website including listing at least one item for purchase is received. A prompt is assembled such that the prompt includes (i) the extracted data describing the at least one item and (ii) rules describing what constitutes a leasable good. The prompt is sent to a large language model. In response to the prompt, an indication whether the at least one item is the leasable good is received from the large language model. When the at least one item is indicated to be a leasable good, data necessary to purchase the item is injected into the website. And, a lease transaction of the item to the customer is completed.

### CROSS-REFERENCE TO RELATED APPLICATIONS

This application claims the benefit of U.S. Nonprovisional Patent Application No. 19/184,948, filed on Apr. 21, 2025, the content of which is incorporated by reference.

### BACKGROUND

A lease-to-own transaction for personal property, such as furniture, household appliances, electronics or other durable goods, allows a customer to lease an item on a short-term, renewable basis, with various options, but not the obligation, to acquire ownership if elected by the customer. Lease-to-own is offered by leasing companies to consumers through a variety of distribution channels, including in-store and online through third party retailers, enabling consumers who may not have sufficient credit or savings or who otherwise seek the optionality of a lease-to-own transaction to access these goods on flexible terms with no long-term obligation. The customer typically makes optional renewal payments on a weekly, biweekly or monthly basis and can, as provided by their lease agreements, elect to renew the lease for a specified number of lease terms to ultimately acquire ownership, exercise an early purchase option, terminate the transaction or reinstate their lease following termination.

In e-commerce, lease-to-own transactions may be integrated into online third party retailer platforms to provide customers with a flexible lease-to-own option at checkout or may be otherwise offered by leasing companies to customers using technologies and processes that allow the customers to enter lease-to-own transactions with respect to products available on a third party e-commerce platform. When lease-to-own transactions are offered by leasing companies through the third party retailer channel, whether in-store or online, customers select eligible items from the third party retailers’ inventory and, if approved by the leasing company, the leasing company purchases the eligible item from the third party retailer and leases it to the customer on a lease-to-own basis.

Customers can lease-to-own goods for sale on e-commerce websites. However, not all items for sale on third party e-commerce websites may be leasable. For example, consumable goods, such as food or trash bags, are typically not leasable and items below a certain minimum dollar amount may also not be leasable. A catalog may be maintained by the lease-to-own company identifying which third party e-commerce items are leasable and which are not. However, this catalog may be difficult and in some cases impossible to keep up to date. For a lease-to-own entity to integrate into a third party e-commerce website, the lease-to-own entity may need to have prior knowledge of the structure of the third party retailer’s e-commerce website.

Improved systems and methods are needed to identify whether items in online shopping carts are leasable.

### BRIEF SUMMARY

In an embodiment, a computer-implemented method for enabling an interface to an e-commerce site. Data describing the at least one item from a retail ecommerce website including listing at least one item for purchase is received. A prompt is assembled such that the prompt includes (i) the extracted data describing the at least one item and (ii) rules describing what constitutes a leasable good. The prompt is sent to a large language model. In response to the prompt, an indication whether the at least one item is the leasable good is received from the large language model. When the at least one item is indicated to be a leasable good, data necessary to purchase the item is injected into the website. And, a lease transaction of the item to the customer is completed.

System, device, and computer program product aspects are also disclosed.

Further features and advantages, as well as the structure and operation of various aspects, are described in detail below with reference to the accompanying drawings. It is noted that the specific aspects described herein are not intended to be limiting. Such aspects are presented herein for illustrative purposes only. Additional aspects will be apparent to persons skilled in the relevant art(s) based on the teachings contained herein.

### BRIEF DESCRIPTION OF THE DRAWINGS

The accompanying drawings are incorporated herein and form a part of the specification.

FIG. 1 shows a block diagram of a system for providing a leasability engine that interprets e-commerce data to determine whether items are leasable, according to an embodiment.

FIG. 2 shows a method for determining whether an item is leasable, according to an embodiment.

FIG. 3 shows a method for completing a lease-to-own transaction on an e-commerce site once an item determined to be leasable.

FIGS. 4A-B illustrate example user interfaces for e-commerce shopping.

FIGS. 5A-C illustrate example user interfaces that may be used during evaluation of whether an item is leasable.

FIGS. 6A-D illustrate example user interfaces that may be used during closing of a lease-to-own transaction.

FIGS. 7A-C illustrate example user interfaces for may be used to purchase an item using an online lease-to-own transaction.

FIG. 8 shows an example computer system useful for implementing various aspects of this disclosure.

In the drawings, like reference numbers generally indicate identical or similar elements. Additionally, generally, the left-most digit(s) of a reference number identifies the drawing in which the reference number first appears.

### DETAILED DESCRIPTION

Consumers can shop on e-commerce sites using a mobile application. The mobile application provides the consumer an option to rent goods available on the e-commerce sites. To offer such an option, the mobile application needs to distinguish between durable goods, which qualify as being rentable, and nondurable goods, which do not. Aspects of this invention analyze, using a large language model, text on the website presentation of a shopping cart to distinguish those goods that are durable from those that are not. In this way, embodiments obviate the need for a separate catalog listing whether each item is leasable that is difficult or impossible to maintain accurately. Thus, aspects of the invention provide a technical improvement in data coherence and management.

As mentioned above, in prior art systems, this data coherence problem arises only in the context of the ephemeral nature of an Internet “location” or the near-instantaneous transport between these locations made possible by standard Internet communication protocols. There is no brick-and-mortar analog, because in physical retail stores there need not be a separate listing of what is leasable. Thus, the improvement presented here is technical in nature.

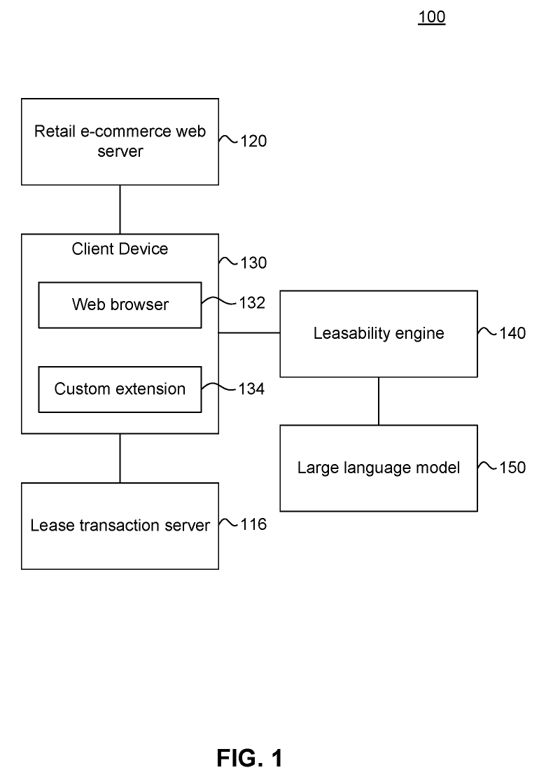

FIG. 1 is a block diagram illustrating system 100 for enabling an interface to an e-commerce site that determines leasability of items and facilitates lease transactions, according to some embodiments. System 100 may include a retail e-commerce web server 120, a client device 130, a leasability engine 140, a large language model 150, and a lease transaction server 116. Any operation herein may be performed by any type of structure in the diagram, such as a module or dedicated device, in hardware, software, or any combination thereof.

In some embodiments, system 100 may allow customers to lease-to-own goods for sale on e-commerce websites by analyzing product data to distinguish between leasable durable goods and non-leasable items like nondurable goods. This may obviate the need for maintaining a separate catalog of leasable items that could be difficult to keep updated.

Retail e-commerce web server 120 may host the online shopping website where customers can browse and add items to their cart. It may be implemented as a server or group of servers that may include hardware components such as processors, memory, and network interfaces, as well as software components like web server software, database management systems, and e-commerce platform software. Web server 120 may serve web pages containing product listings, descriptions, prices, and images to client devices 130 via web browsers 132. It may process requests from client devices 130 to add items to shopping carts, initiate checkout processes, and complete purchase transactions. The web server 120 may also manage inventory, track orders, and handle other backend e-commerce functions.

In some embodiments, retail e-commerce web server 120 may implement a microservices architecture, with separate services handling product catalog management, inventory tracking, order processing, and customer management. This modular approach could allow for easier scaling and maintenance of the e-commerce platform.

Client device 130 may be a user device such as a smartphone, tablet, laptop, desktop computer, or other computing device capable of accessing and interacting with retail e-commerce web server 120 via a network connection. Client device 130 may include web browser 132 for rendering and displaying web pages from retail e-commerce web server 120. Web browser 132 may be any standard web browser application such as Chrome, Firefox, Safari, etc., capable of rendering HTML (Hypertext Markup Language) and executing JavaScript. Web browser 132 may also be a customized browser by virtue of custom extension 134.

In some embodiments, client device 130 may be a smart TV, gaming console, or other Internet-connected device capable of displaying e-commerce websites and facilitating online shopping experiences.

Web browser 132 may retrieve web pages and other resources from retail e-commerce web server 120 and display them to the user on client device 130. It may work in conjunction with custom extension 134 to enable the lease-to-own functionality. When the user is viewing a shopping cart page, web browser 132 may allow custom extension 134 to inject client-side scripts that extract data about items in the cart. Web browser 132 may then facilitate sending this extracted data to leasability engine 140 for processing.

If leasability engine 140 determines an item is leasable, web browser 132 may display lease offer information to the user as overlaid or injected content on the shopping cart page. Web browser 132 may also enable the user to initiate and complete a lease transaction through its interface, working with custom extension 134 to communicate with lease transaction server 116 as needed.

Custom extension 134 may be implemented as a browser extension, plugin, or add-on that extends the functionality of web browser 132. It may be configured to interact with the rendered web pages from retail e-commerce web server 120 to extract product data and facilitate the lease-to-own transaction process. Custom extension 134 may inject client-side scripting functions into shopping cart pages rendered by web browser 132. These injected scripts may allow custom extension 134 to access and parse the HTML structure and content of the shopping cart page to identify individual items and extract relevant data such as product names, descriptions, prices, and quantities.

In some embodiments, custom extension 134 could be implemented as a standalone application that integrates with web browser 132 through APIs (application programming interfaces) or inter-process communication. This approach may provide more flexibility and control over the extension's functionality, especially on mobile devices where browser extensions may have limitations.

Custom extension 134 may perform functions such as extracting product data from shopping cart pages, communicating with leasability engine 140 to determine if items are leasable, injecting UI elements into web pages to offer lease-to-own options, collecting user information needed for lease transactions, and interfacing with lease transaction server 116 to complete lease-to-own purchases.

The extracted item data may be formatted by custom extension 134 into a structured payload, such as JavaScript Object Notation (JSON), containing details on the items in the user's cart. Custom extension 134 may transmit this payload to leasability engine 140 for analysis of whether the items qualify as leasable goods.

If leasability engine 140 determines that items in the cart are leasable, custom extension 134 may modify the rendered shopping cart page to inject user interface elements allowing the user to initiate a lease transaction for qualifying items. This could include adding "Lease to Own" buttons or options next to leasable items.

When a user chooses to lease an item, custom extension 134 may facilitate the lease transaction by communicating with lease transaction server 116. It may inject temporary credit card information provided by lease transaction server 116 into the checkout process on the e-commerce site to complete the initial purchase on behalf of the leasing company.

Leasability engine 140 may be implemented as a software module or component that interfaces between the client device 130 and the large language model 150 to determine whether items are leasable. Leasability engine 140 may receive data describing items (such as from the custom extension 134 on the client device 130), assemble prompts containing that item data along with leasability rules, send the prompts to the large language model 150, and interpret the responses to determine item leasability.

In some embodiments, leasability engine 140 may employ a caching mechanism to store recent leasability determinations for frequently encountered items. This could improve response times and reduce the load on the large language model 150 for common products.

Large language model 150 may be implemented as an artificial intelligence system trained on a large corpus of text data to perform natural language processing tasks. In the context of system 100, large language model 150 may be utilized by leasability engine 140 to analyze product data and determine whether items are leasable. In some embodiments, large language model 150 could be replaced or supplemented with a specialized machine learning model trained specifically on product data and leasability criteria. This could potentially improve accuracy and processing speed for the specific task of determining item leasability.

Large language model 150 may receive prompts from leasability engine 140 that include extracted product data describing items from retail e-commerce web server 120, as well as rules and guidelines for determining leasability. Based on this input, large language model 150 may apply its natural language understanding capabilities to evaluate the product descriptions and characteristics against the provided leasability criteria.

The output from large language model 150 may be an indication of whether each analyzed item is determined to be leasable or not. This binary leasability determination may be sent back to leasability engine 140 for further processing. By leveraging the advanced language comprehension abilities of large language model 150, system 100 may be able to make intelligent leasability assessments without relying on a static catalog or database of pre-classified items.

Large language model 150 may be implemented using various machine learning architectures such as transformer models, and can be fine-tuned or prompted specifically for the task of leasability classification. The use of large language model 150 may allow system 100 to handle the dynamic nature of e-commerce inventory and make real-time leasability decisions as users browse and add items to their carts.

Lease transaction server 116 may be responsible for facilitating and processing lease transactions for items determined to be leasable. When the leasability engine 140 indicates that an item is leasable based on the analysis by the large language model 150, lease transaction server 116 may receive from the client device 130 customer data and transaction data.

Lease transaction server 116 may then initiate and manage the lease-to-own transaction process. This may involve generating a lease agreement for the specific item and customer, processing a first payment on the lease, and creating a single-use credit card for the ecommerce purchase. Using this single-use credit card, web browser 130 may complete the purchase of the item from retail e-commerce web server 120.

In additional embodiments, lease transaction server 116 may also set up recurring payments for the lease renewal terms if elected by the customer, track the status of the lease over time, manage early purchase options if offered, and transfer ownership to the customer upon successful completion of the lease renewal terms or exercise of an early purchase option. Lease transaction server 116 may interface with other financial systems and databases as needed to verify customer information, process payments, and manage ongoing leases. It may maintain records of all active leases and their current status.

By leveraging the large language model 150 to dynamically assess leasability based on current product information, system 100 may provide a technical improvement in data coherence and management compared to maintaining static catalogs. This solution may be particularly suited for the ephemeral nature of online product listings and rapid changes in e-commerce inventories.

By operating within web browser 132 on client device 130, custom extension 134 may enable seamless integration of lease-to-own capabilities into existing e-commerce websites without requiring changes to the retail e-commerce web server 120 itself. This may allow the system to determine leasability and facilitate lease transactions across multiple e-commerce platforms.

By centralizing the lease transaction process, lease transaction server 116 may allow system 100 to seamlessly integrate lease-to-own capabilities with standard e-commerce purchasing, providing customers an additional flexible payment option without requiring major changes to the core functionality of the retail e-commerce web server 120.

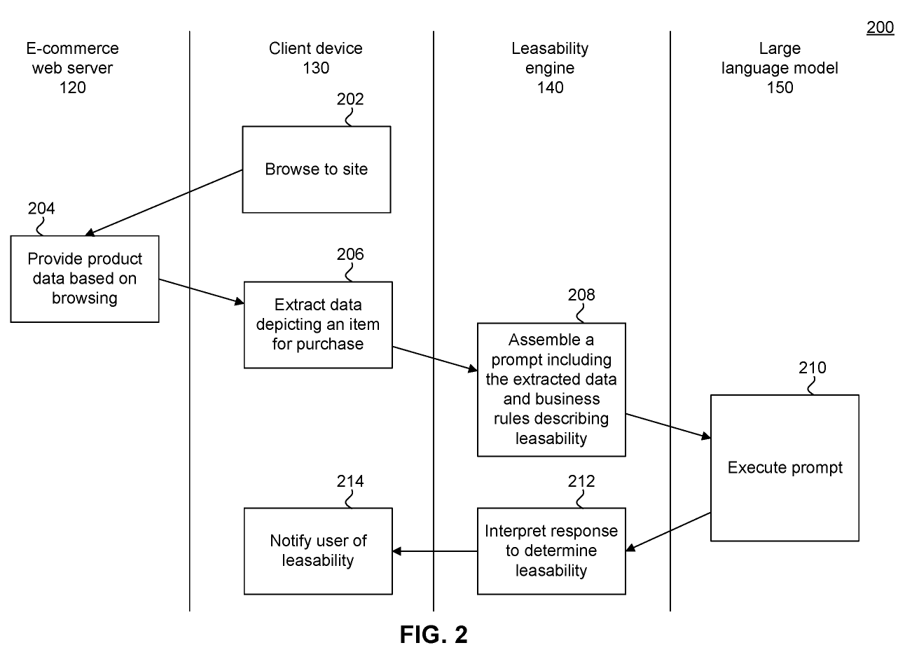

FIG. 2 is a flowchart illustrating a method 200 for enabling an interface to an e-commerce site and determining leasability of items, according to some embodiments. Method 200 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 2, as will be understood by a person of ordinary skill in the art.

Method 200 shall be described with reference to FIG. 1. However, method 200 is not limited to that example embodiment. The method 200 may involve interactions between a retail e-commerce web server 120, a client device 130, a leasability engine 140, and a large language model 150 to analyze product data and determine if items are eligible for lease transactions.

In some embodiments, at step 202, a user may browse to an e-commerce website using a web browser 132 on the client device 130. This may initiate the process of potentially identifying leasable items on the e-commerce site. As the user navigates through product pages, categories, or search results, the web browser 132 may send requests to and receive responses from the e-commerce web server 120. The client device 130 could be a smartphone, tablet, laptop, or desktop computer. The web browser 132 may be any modern browser such as Chrome, Firefox, Safari, or Edge.

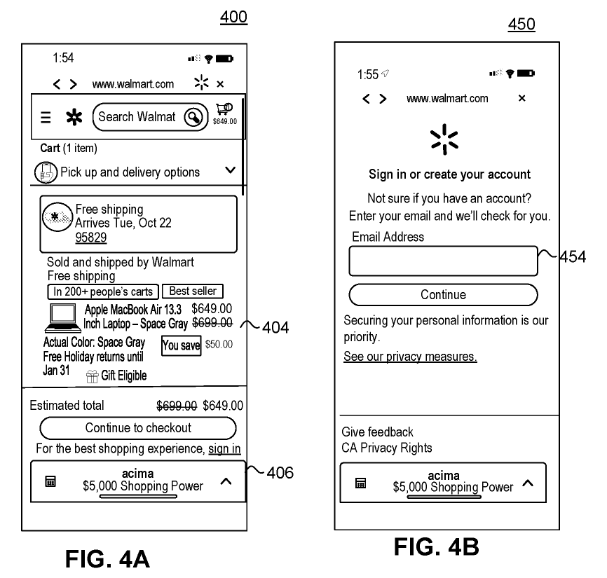

In step 204, the e-commerce web server 120 may provide product data based on the user's browsing activity. This may include details about items the user is viewing or has added to their shopping cart, such as product names, descriptions, images, pricing, and other relevant attributes. The data provided at this stage may represent standard product information shown to any user browsing the site, before any lease-specific processing occurs. In some embodiments, this data could be structured as HTML, JSON, or XML, depending on the e-commerce platform's implementation. An example of web browsing and the return data are illustrated in the user interfaces in FIGS. 4A-B.

FIGS. 4A-B illustrate example user interfaces for e-commerce shopping. FIG. 4A illustrates a user interface 400. User interface 400 includes a shopping cart listing 404 that includes a product name, description, image, and pricing. User interface 400 further includes an overlay 406 that when selected allows a user to view more information about her lease-to-own options. Overlay 406 may be generated by custom extension 134.

At step 206, data depicting items the user is interested in purchasing may be extracted, likely by custom extension 134 running in the web browser 132 on the client device 130. The custom extension 134 could be implemented as a browser plugin or add-on capable of accessing and parsing the HTML, CSS, and JavaScript of the rendered pages. It may analyze the DOM structure to identify elements containing product information and extract relevant data for each item of interest. In various embodiments, the custom extension 134 could use HTML element ID, XPath or CSS selectors to target specific elements containing product information.

The custom extension 134 may be configured with site-specific extraction rules to properly parse the structure and content from different e-commerce websites. This may allow the data extraction to be tailored to the particular layout and format used by each retail site. By extracting data directly from the rendered pages, the system could obtain up-to-date information about items the user is considering purchasing, without relying on a separate product catalog that may become outdated.

In an alternative embodiment, instead of a browser extension, the extraction could be performed by a standalone application or a server-side process that analyzes network traffic between the client device 130 and the e-commerce web server 120. The extracted product data may then be sent to the leasability engine 140. In another embodiment, the product data may then be sent to the leasability engine 140 not from custom extension 134 from scripts in the page provided by web server 120 that are executed by web browser 132. In a still further embodiment, the product data may then be sent to the leasability engine 140 by web server 120, which uses the leasability determination to generate a page sent to client device 130.

In step 208, leasability engine 140 receives the item data and assembles a prompt including the extracted data and business rules describing what constitutes a leasable item. Leasability engine 140 may determine a category for the product to include in the item data. Leasability engine 140 may determine the category based on the source e-commerce website. For example if server 120 is an ecommerce website for a sunglasses retailer, then the category is likely to be sunglasses. The assembled prompt could be carefully constructed to provide clear guidelines to the large language model 150 about how to assess leasability. In one embodiment, the leasability engine 140 may be implemented as a microservice running in a cloud environment, allowing for scalability and easy updates to business rules.

The prompt assembled by the leasability engine 140 may include the extracted item data (e.g., product name, description, price, category, the source e-commerce website etc.), explicit rules describing leasability criteria, instructions for the large language model 150 to provide a binary (yes/no) decision on lease ability. The rules include guidelines on categories or specific items that should or should not be considered leasable. For example, in general, most durable goods are leasable and all nondurable goods may not be leasable. The prompt may include specific examples of consumer goods that are considered durable (e.g., furniture, mattresses, tires, appliances, electronics, laptops, electric bicycles, video game systems, jewelry) and examples of goods that are considered nondurable (ink cartridges, items meant to be permanently attached to a home or vehicle, consumables, food). The prompt may list some categories of durable goods that are not leasable, such as weapons, and provide examples of goods that fall into that category (e.g., handguns, swords). The prompt may also have a business rule that a service (such as a warranty), is considered leasable if it has a $0 price (e.g., it is a free add-on to an otherwise leasable good).

In step 210, the assembled prompt may be sent to and executed by the large language model 150. The model may analyze the product data against the provided leasability rules, applying its natural language understanding capabilities to interpret the item description and compare it against the leasability criteria. This could involve analyzing product categories, material composition, expected lifespan, and other relevant factors to determine if the item qualifies as a durable, leasable good.

The large language model 150 may be implemented using various natural language processing architectures such as transformer models, recurrent neural networks, or other suitable machine learning models trained on large corpora of data, including text data. It could be configured to understand natural language prompts and context, and provide relevant responses based on its training. In one embodiment, the model may be based on GPT-3 or a similar architecture, fine-tuned on e-commerce product data and leasability criteria.

The leasability engine 140 may then interpret the response from the large language model 150 in step 212 to determine if the analyzed items are leasable or not. This interpretation could translate the model's output into a clear leasability determination. The interpretation process may involve parsing structured output or natural language responses, looking for specific keywords or phrases that indicate leasability, or evaluating confidence scores if provided by the model.

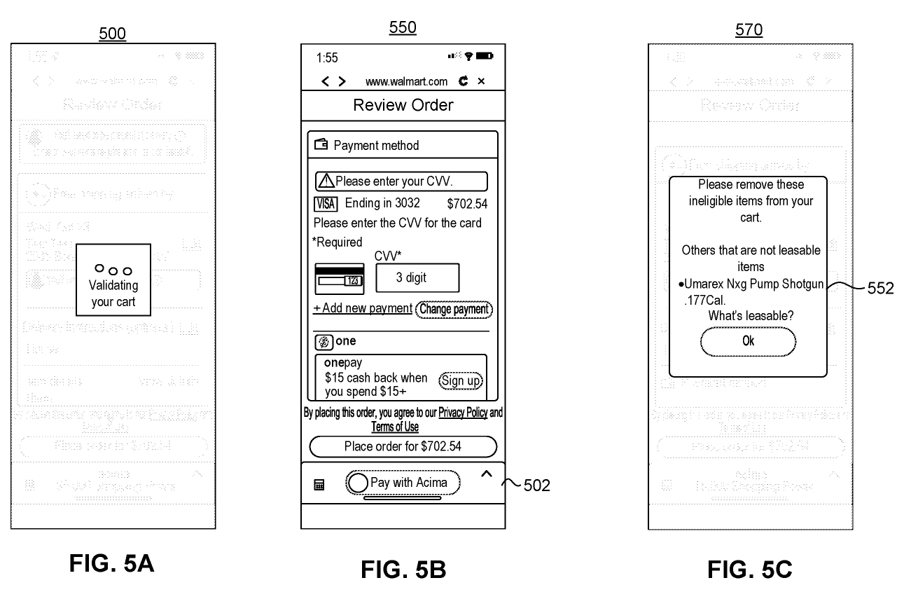

Finally, in step 214, the client device 130 may be notified of the leasability determination, likely through the custom extension 134. This could allow the user interface to be updated to reflect which items are eligible for lease transactions. The notification may be displayed to the user via the web browser 132 or custom extension 134, informing them whether the item qualifies for a lease-to-own transaction. An example of how to notify the user as to leasability is illustrated in the user interfaces in FIGS. 5A-C.

FIGS. 5A-C illustrate example user interfaces that may be used during evaluation of whether an item is leasable. FIG. 5A illustrates a user interface 500 that shows a display that may be presented to a user while leasability of items in the cart is being determined. FIG. 5B illustrates a user interface 550 that may be presented when all items in the cart are determined to be leasable. User interface 550 includes a button 552 to initiate the lease transaction. Button 552 may be generated by custom extension 134. FIG. 5C illustrates a user interface 570 that may be presented when at least one item in the cart are determined to be leasable. User interface 570 includes a message 572 notifying the user of the determination and instructing the user to remove the non-leasable items from the shopping cart. Message 572 may also be generated by custom extension 134.

By leveraging the natural language processing capabilities of the large language model 150, method 200 may provide an efficient and adaptable way to assess item leasability without relying on static catalogs or databases. This could enable a more flexible and up-to-date leasing option for e-commerce customers. The system may dynamically assess leasability of new or changing product offerings on the e-commerce site in real-time, providing accurate and timely feedback to users as they shop.

In an alternative embodiment, the system could employ a hybrid approach, combining the large language model's analysis with a traditional database of known leasable and non-leasable items. This may serve as a fallback mechanism or a way to quickly handle common cases without invoking the more computationally intensive language model 150. The database could be periodically updated based on the decisions made by the large language model 150, creating a self-improving system over time.

Another potential embodiment could involve using the large language model 150 to generate explanations for its leasability decisions. These explanations may be used to provide more detailed feedback to users about why an item is or isn't leasable, or to help refine the business rules used in the decision-making process.

The method 200 could also be extended to handle multi-item carts or bundles. In this scenario, the leasability engine 140 might need to make decisions about the leasability of the entire cart, considering factors like the mix of items, total value, and any package deals or discounts applied.

In some embodiments, the extension UI may also provide real-time updates on item leasability as the user adds or removes items from their cart. This could involve dynamically adjusting the overlay to reflect changes in the cart contents, potentially ensuring that the user always has up-to-date information on which items are eligible for leasing.

Overall, the method 200 may represent a flexible and scalable approach to determining item leasability in e-commerce contexts. By leveraging advanced natural language processing capabilities of the large language model 150, it could adapt to a wide range of products and e-commerce platforms, providing a robust solution to the challenge of maintaining accurate leasability information in a rapidly changing online retail landscape.

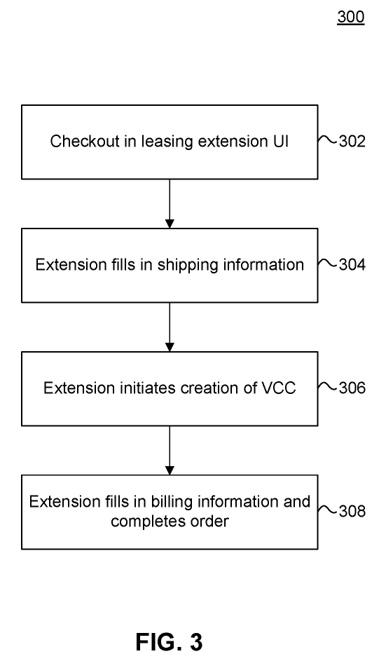

FIG. 3 is a flowchart illustrating a method 300 for enabling a lease transaction interface on an e-commerce website using a custom browser extension, according to some embodiments. Method 300 may be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 3, as will be understood by a person of ordinary skill in the art.

Method 300 shall be described with reference to FIG. 1. However, method 300 is not limited to that example embodiment.

The steps of method 300 may be performed by components of system 100, such as the custom extension 134 running within web browser 132 on client device 130, in conjunction with leasability engine 140 and lease transaction server 116. Method 300 may enable the custom extension 134 to overlay additional user interface elements and functionality onto the existing e-commerce website interface to facilitate the lease transaction process.

By providing this seamless integration with existing e-commerce sites, method 300 may allow lease-to-own companies to offer their services across a wide range of online retailers without requiring direct integration or partnerships. The method may leverage the custom browser extension 134 to inject the necessary functionality at the client side, potentially providing a flexible and scalable approach to enabling lease transactions.

At step 302, checkout is initiated in the leasing extension UI. After the extension UI is overlaid on the cart as described about for FIG. 2, the user may interact with the extension UI to initiate the checkout process for leasing the item(s) in the cart. This may involve the user selecting a "Lease to Own" or similar option presented by the extension UI, such as illustrated by button 552 in FIG. 5B. Upon receiving this user input, the extension 134 may proceed to the checkout flow for leasing rather than standard purchasing.

The checkout choice made through the extension UI may allow the subsequent steps to be tailored specifically for completing a lease transaction, rather than a standard purchase transaction on the e-commerce site 120. By providing this option through the extension 134, the method may enable lease-to-own functionality to be added to e-commerce sites that may not natively support such transactions, potentially enhancing the flexibility of payment options for users without requiring changes to the underlying e-commerce platform.

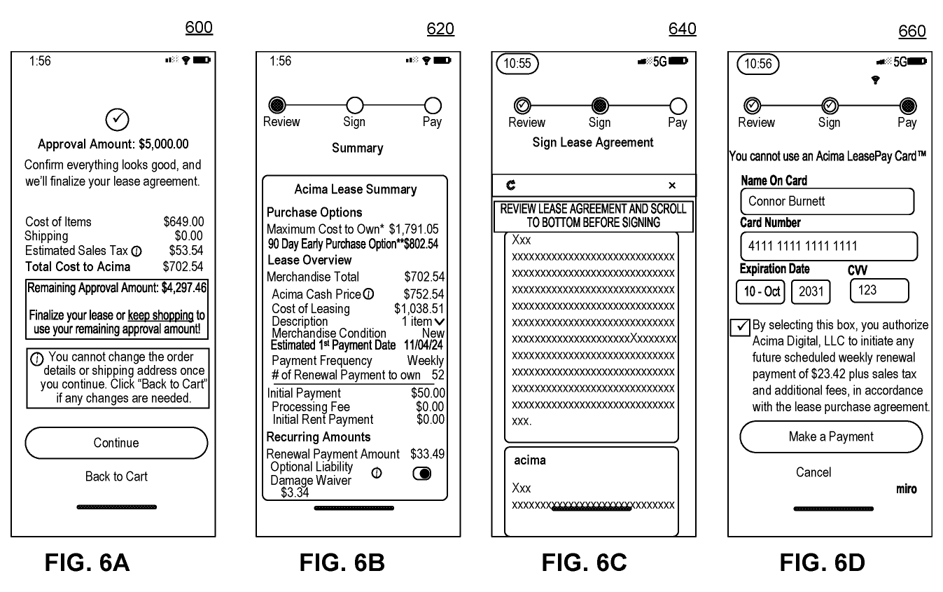

FIGS. 6A-D illustrate example user interfaces that may be used during closing of a lease-to-own transaction. At this point, the items in cart have already been validated as leasable. Custom extension 134 may determine that the shopping cart amount is below the user’s total approval amount. To notify the user of that determination, custom extension 134 may generate a user interface 600 as illustrated in FIG. 6A. After the user selects to continue on user interface 600, custom extension 134 may present to the user lease term details, as illustrated by a user interface 620 in FIG. 6B, and may enable the user to execute the lease agreement, as illustrated by a user interface 640 in FIG. 6C. Finally, custom extension 134 asks that the user make a first payment on the lease, as illustrated by a user interface 620 in FIG. 6D.

At step 304, the extension may optionally fill in shipping information. For example, after the user has chosen to proceed with checkout using the extension UI in step 302, the custom extension 134 on the client device 130 may automatically populate shipping information fields on the retail e-commerce website 120. This shipping information may be retrieved from user profile data stored by the extension 134 or lease transaction server 116.

By automatically filling in the shipping details, the extension 134 may streamline the checkout process for the user and reduce the amount of manual data entry required. The shipping information may include details such as the user's name, shipping address, phone number, and any special delivery instructions. This step may help prepare the order for processing by the retail e-commerce web server 120 and eventual fulfillment. The automated population of shipping details by the extension 134 may improve the user experience and efficiency of the lease-to-own transaction flow. It also may prevent fraud by ensuring that the good is shipped to the lessee.

At step 306, the extension may initiate creation of a virtual credit card (VCC). After the extension 134 fills in the shipping information in step 304, it may proceed to initiate the creation of a VCC to be used for completing the lease transaction. This VCC creation process may involve the extension 134 communicating with lease transaction server 116 to request generation of a single-use virtual credit card number and associated details.

The VCC may be a temporary payment instrument that could be used specifically for this lease transaction, potentially providing an added layer of security and financial control. By using a VCC, the actual credit card information of the customer may not be exposed to the retail e-commerce web server 120, potentially reducing security risks. The VCC may typically be created with a credit limit that matches the total cost of the leasable items in the cart, potentially ensuring that only the intended transaction can be processed.

This step may be crucial in preparing for the final stage of the lease transaction, setting up a secure payment method that is specifically tailored for the lease-to-own process facilitated by the system 100.

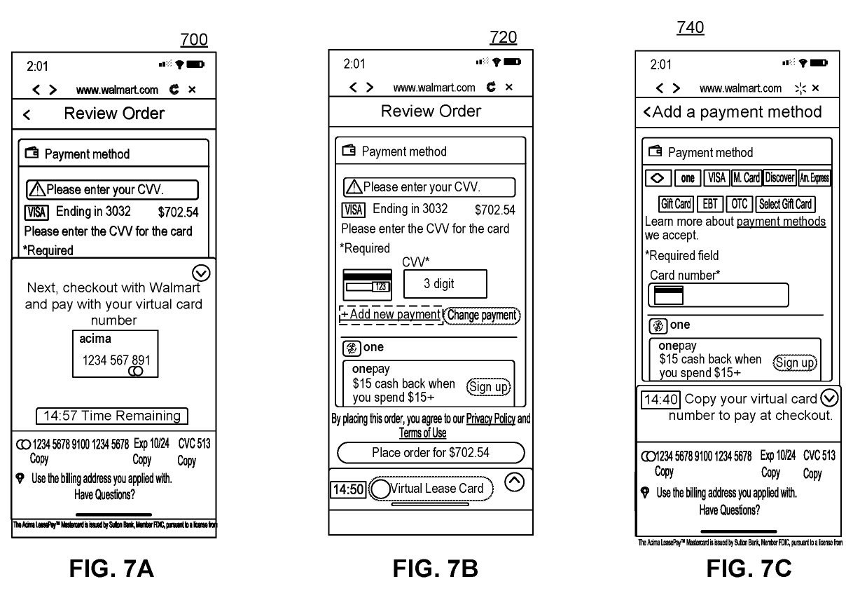

At step 308, the extension 134 may fill in billing information and complete the order. After the extension 134 initiates creation of the virtual credit card (VCC) in step 306, it may proceed to fill in the billing information associated with the VCC and complete the lease transaction order. Specifically, the extension 134 may automatically populate the billing fields on the e-commerce checkout page with the VCC information, such as the card number, expiration date, and CVV code. This may eliminate the need for the user to manually enter payment details. Alternatively, the extension 134 may require that a user copy and paste billing information into the checkout page. An example of how payment details can be entered is illustrated in FIGS. 7A-C.

FIGS. 7A-C illustrate example user interfaces that may be used to purchase an item using an online lease-to-own transaction. The extension 134 generates an interface presenting the VCC card number (e.g., Primary Account Number, or PAN), expiration date, and CVC code, as illustrated on FIGS. 7B and 7C. The user copies that information into the ecommerce checkout page as illustrated by adding a new payment method, as illustrated in interface 720 in FIG. 7B and interface 740 in FIG. 7C.

The order form with the populated VCC billing information may be submitted to complete the lease transaction. The completed order may then be processed by the retail e-commerce web server 120 and fulfilled according to the merchant's normal procedures, while the lease transaction server 116 may manage the backend lease agreement and payments.

The method 300 may also include steps for handling partial cart leasability, where only some items in the cart are eligible for leasing. In such cases, the extension 134 may offer a split transaction option, potentially allowing users to lease eligible items while purchasing others outright.

By following the steps outlined in method 300, the system 100 may enable a seamless and user-friendly process for conducting lease-to-own transactions on third-party e-commerce websites. This approach may expand the reach of lease-to-own services while maintaining a consistent and secure transaction experience for users across different online retail platforms.

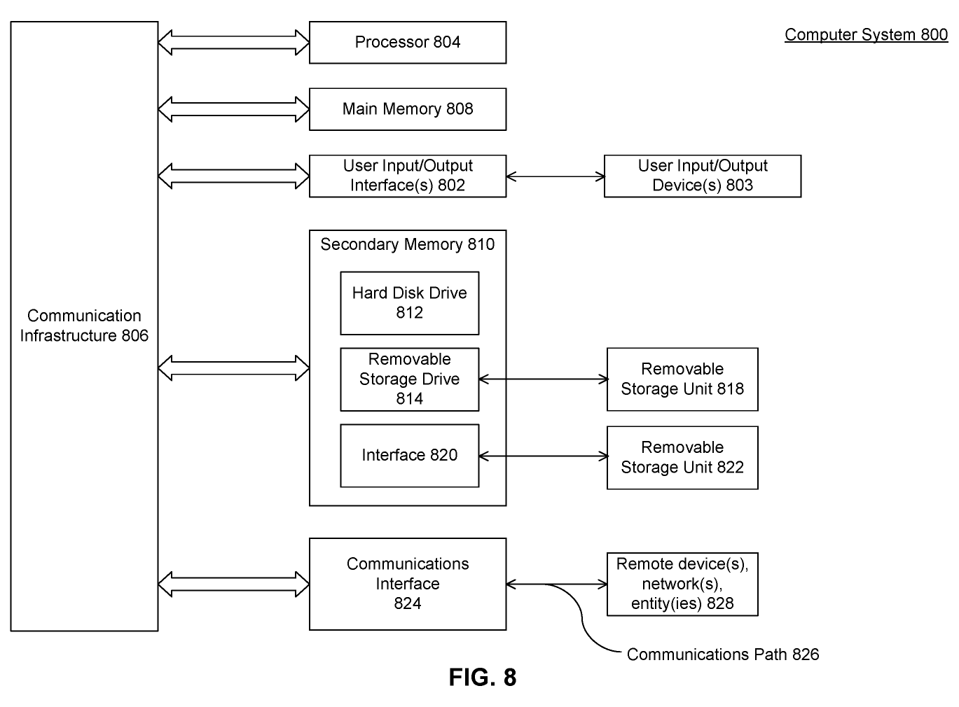

Various embodiments may be implemented, for example, using one or more well-known computer systems, such as computer system 800 shown in FIG. 8. One or more computer systems 800 may be used, for example, to implement any of the embodiments discussed herein, as well as combinations and sub-combinations thereof.

Computer system 800 may include one or more processors (also called central processing units, or CPUs), such as a processor 804. Processor 804 may be connected to a communication infrastructure or bus 806.

Computer system 800 may also include user input/output device(s) 803, such as monitors, keyboards, pointing devices, etc., which may communicate with communication infrastructure 806 through user input/output interface(s) 802.

One or more of processors 804 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 800 may also include a main or primary memory 808, such as random access memory (RAM). Main memory 808 may include one or more levels of cache. Main memory 808 may have stored therein control logic (i.e., computer software) and/or data.

Computer system 800 may also include one or more secondary storage devices or memory 810. Secondary memory 810 may include, for example, a hard disk drive 812 and/or a removable storage device or drive 814. Removable storage drive 814 may be a floppy disk drive, a magnetic tape drive, a compact disk drive, an optical storage device, tape backup device, and/or any other storage device/drive.

Removable storage drive 814 may interact with a removable storage unit 818. Removable storage unit 818 may include a computer usable or readable storage device having stored thereon computer software (control logic) and/or data. Removable storage unit 818 may be a floppy disk, magnetic tape, compact disk, DVD, optical storage disk, and/ any other computer data storage device. Removable storage drive 814 may read from and/or write to removable storage unit 818.

Secondary memory 810 may include other means, devices, components, instrumentalities or other approaches for allowing computer programs and/or other instructions and/or data to be accessed by computer system 800. Such means, devices, components, instrumentalities or other approaches may include, for example, a removable storage unit 822 and an interface 820. Examples of the removable storage unit 822 and the interface 820 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 800 may further include a communication or network interface 824. Communication interface 824 may enable computer system 800 to communicate and interact with any combination of external devices, external networks, external entities, etc. (individually and collectively referenced by reference number 828). For example, communication interface 824 may allow computer system 800 to communicate with external or remote devices 828 over communications path 826, which may be wired and/or wireless (or a combination thereof), and which may include any combination of LANs, WANs, the Internet, etc. Control logic and/or data may be transmitted to and from computer system 800 via communication path 826.

Computer system 800 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 800 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 800 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 800, main memory 808, secondary memory 810, and removable storage units 818 and 822, as well as tangible articles of manufacture embodying any combination of the foregoing. Such control logic, when executed by one or more data processing devices (such as computer system 800), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 8. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A computer-implemented method for enabling an interface to an e-commerce site, comprising:
receiving data describing the at least one item from a retail ecommerce website including listing to a user at least one item for purchase;
assembling a prompt including (i) the extracted data describing the at least one item and (ii) rules describing what constitutes a leasable good;
sending the prompt to a large language model;
in response to the prompt, receiving, from the large language model, an indication whether the at least one item is the leasable good; and
when the at least one item is indicated to be a leasable good:
injecting data necessary to purchase the item into the website; and
completing a lease transaction of the item to the user.

2. The method of claim 1, wherein the rules describing what constitutes a leasable good comprise an indication that durable goods are leasable, a definition of a durable good, and a list of examples of durable goods.

3. The method of claim 2, wherein the rules further comprise an instruction that output from the large language model should be binary.

4. The method of claim 1, further comprising:
extracting the data describing the at least one item from a shopping cart page of the retail ecommerce website.

5. The method of claim 4, further comprising:
selecting, based on the retail ecommerce website, a client side scripting function, the selected client side function adapted to extract the data describing the at least one item from the retail ecommerce website.

6. The method of claim 5, wherein injecting the client side scripting function into the shopping cart page such that the client side scripting function is executed when the shopping cart page is rendered on a web browser.

7. The method of claim 4, further comprising, when the at least one item is not to be a leasable good, removing from the item from the shopping cart.

8. The method of claim 1, wherein the data is received from the retail ecommerce website.

9. The method of claim 1, wherein the data necessary to purchase the item includes credit card information for a single transaction credit card.

10. The method of claim 1, wherein the extracted data describes a plurality of items and wherein the receiving the indication comprises receiving an indication whether each of the plurality items is the leasable good.

11. A non-transitory computer-readable device having instructions stored thereon that, when executed by at least one computing device, cause the at least one computing device to perform operations comprising:
receiving data describing the at least one item from a retail ecommerce website including listing to a user at least one item for purchase;
assembling a prompt including (i) the extracted data describing the at least one item and (ii) rules describing what constitutes a leasable good;
sending the prompt to a large language model;
in response to the prompt, receiving, from the large language model, an indication whether the at least one item is the leasable good; and
when the at least one item is indicated to be a leasable good:
injecting data necessary to purchase the item into the website; and
completing a lease transaction of the item to the user.

12. The device of claim 11, wherein the rules describing what constitutes a leasable good comprise an indication that durable goods are leasable, a definition of a durable good, and a list of examples of durable goods.

13. The device of claim 12, wherein the rules further comprise an instruction that output from the large language model should be binary.

14. The device of claim 11, further comprising:
extracting the data describing the at least one item from a shopping cart page of the retail ecommerce website.

15. The device of claim 14, further comprising:
selecting, based on the retail ecommerce website, a client side scripting function, the selected client side function adapted to extract the data describing the at least one item from the retail ecommerce website.

16. The device of claim 15, wherein injecting the client side scripting function into the shopping cart page such that the client side scripting function is executed when the shopping cart page is rendered on a web browser.

17. The device of claim 11, further comprising, when the at least one item is not to be a leasable good, removing from the item from the shopping cart.

18. The device of claim 14, wherein the data is received from the retail ecommerce website.

19. The device of claim 11, wherein the data necessary to purchase the item includes credit card information for a single transaction credit card.

20. A system for enabling an interface to an e-commerce site, comprising:
at least one processor;
a memory;
a leasability engine, executed on the at least one processor, configured to:
receive data describing the at least one item from a retail ecommerce website including listing to a user at least one item for purchase,
assemble a prompt including (i) the extracted data describing the at least one item and (ii) rules describing what constitutes a leasable good,
in response to the prompt, receiving, from the large language model, an indication whether the at least one item is the leasable good, and
a custom extension executed on a client device and configured to, when the at least one item is indicated to be a leasable good, inject data necessary to purchase the item into the website, and interact with a lease transaction server to complete a lease transaction of the item to the user.
